(19) United States
(12) Patent Application Publication
(10) Pub. No.: US 2023/0345880 A1
(43) Pub. Date: Nov. 2, 2023

(54) Billhook for Baler Knotter

(71) Applicant: AGCO Corporation, Duluth, GA (US)

(72) Inventors: David A. Becker, Newton, KS (US); Sascha Reichert, Hesston, KS (US)

(21) Appl. No.: 18/042,797

(22) PCT Filed: Aug. 10, 2021
(86) PCT No.: PCT/IB2021/057364

§ 371 Date: Feb. 24, 2023

Related U.S. Application Data
(60) Provisional application No. 63/080,390, filed on Sep. 18, 2020.

(51) Int. Cl. A01F 15/14

(52) U.S. Cl. CPC A01F 15/145

(57) ABSTRACT

A knotter assembly is used with a baler and configured to form knots in strands of a binding material used to secure a formed bale. The knotter assembly has a rotatably driven knotter disc, a rotary billhook driven by the knotter disc, and a twine disc assembly positioned adjacent the billhook for holding strands of binding material in position for engagement by the billhook. The billhook includes a billhook casting forming a platform, and a billhook tongue connected at a pivot point with the billhook casting. The platform has a first raised lip and a second raised lip forming a channel therebetween configured to receive the billhook tongue so as to firmly grasp the binding material. An upper surface of the first raised lip extends above an upper surface of the second raised lip.

### CROSS REFERENCE TO RELATED APPLICATION

This application claims the benefit of U.S. Provisional Application No. 63/080,390, filed Sep. 18, 2020, which is hereby incorporated by reference in its entirety.

### BACKGROUND OF THE INVENTION

### Field of Invention

This invention relates to relates to agricultural balers having a bale knotting system using twine to bind the bales, and more particularly, to a billhook for such knotting system.

### Description of Related Art

Agricultural balers for binding bales of crop materials with strands of a binding material, such as twine, are well known in the art. Typically, balers are equipped with means to wrap twine around the formed bale and tie off the twine to secure the bale. This includes a knotter assembly having a knotter disc rotated by a powered drive shaft that controls a rotational movement of the components of the knotter assembly. A twine disc holds the twine in position for engagement by a billhook and a swing arm form the knot. For example, U.S. Pat. No. 4,074,623, assigned to Hesston Corporation, which is now part of the assignee of the present application, discloses a typical knotter assembly. The knotter assembly forms a loop made from two strands of binding material, i.e., one strand from a first supply of binding material along the normally top side of the bale and a second strand from a second supply of binding material along the normally bottom of the bale. Two knots appear in the loop at the locations where the strands are joined. Such a knotter assembly uses the billhook for forming the knot, a twine disc in combination with a retainer for retaining the strands when forming the knot, and a wiper arm with an integrated cutter for stripping the formed knot from the billhook in combination with the separation of the knot from the retained strands. When a bale reaches its desired length, a knot tying cycle is initiated. During this tying cycle, two knots are formed, the first knot for closing the loop of the finished bale and the second knot for starting the loop for the next bale.

With the desire to form bales with more densely packed crop material, it is necessary to use heavier twine and form stronger knots. The increased forces in the high density bales put higher stresses on the components of the knotter assembly. Knot creation is a balance of two things, getting the knot created successfully by the system while maximizing tail length. With conventional billhooks, the operator must balance getting the billhook tight enough to create sufficiently long tails so the twine can be cut, but not so tight that the knot gets stuck in the knotter assembly or as to cause knotter assembly parts to wear prematurely. This balancing issue is more difficult with larger twines used with high density balers. It would be desirable to have an improved billhook that allows capacity for tying larger twines while also reducing the necessary billhook tension to produce good tails.

### Overview of the Invention

In one embodiment, the invention is directed to a knotter assembly for use with a baler, the knotter assembly configured to form knots in strands of a binding material used to secure a formed bale. The knotter assembly has a rotatably driven knotter disc, a rotary billhook driven by the knotter disc, and a twine disc assembly positioned adjacent the billhook for holding strands of binding material in position for engagement by the billhook. The billhook includes a billhook casting forming a platform, and a billhook tongue connected at a pivot point with the billhook casting. The platform has a first raised lip and a second raised lip forming a channel therebetween configured to receive the billhook tongue so as to firmly grasp the binding material. An upper surface of the first raised lip extends above an upper surface of the second raised lip.

These and other features and advantages of this invention are described in, or are apparent from, the following detailed description of various exemplary embodiments of the systems and methods according to this invention.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 is side elevation of a baler;

FIG. 2 is a fragmentary, side elevational view of a portion of the baler having a knotter assembly;

FIG. 3 is an enlarged, fragmentary, side elevational view of the knotter assembly, needle and associated mechanism in mid cycle;

FIG. 4 is a side view of a billhook and billhook tongue of the knotter assembly of FIG. 3;

FIG. 5 is a perspective view of the billhook of FIG. 4; and

FIG. 6 is an end view of the billhook of FIG. 4.

Corresponding reference characters indicate corresponding parts throughout the views of the drawings.

### DETAILED DESCRIPTION OF EXEMPLARY EMBODIMENTS

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description. Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “left” or “right” are used as a matter of mere convenience, and are determined by standing at the rear of the machine facing in its normal direction of travel. Furthermore, the various components shown or described herein for any specific application of this invention can be varied or altered as anticipated by this invention and the practice of a specific application of any element may already by widely known or used in the art by persons skilled in the art and each will likewise not therefore be discussed in significant detail. In the description which follows and in certain passages already set forth, the principles of the present invention will be described in terms of “twine” and “knots” formed in such twine. While twine is used in the exemplary embodiment, the term binding material is intended to mean not only twine made from natural or synthetic fibers, but may also include metallic wire or other strapping material.

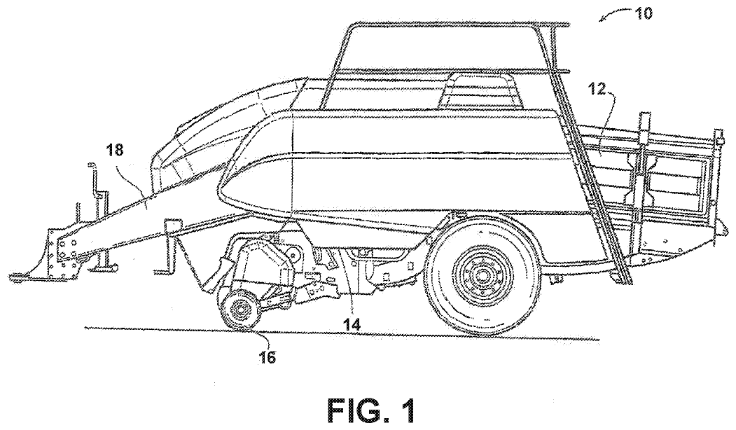

Turning to the figures, wherein like reference numerals represent like elements throughout the several views, FIG. 1 shows a baler 10 with a fore-and-aft extending baling chamber 12 mounted on a baler frame 14 within which bales of crop material are prepared. Crop material is collected with a pickup 16 below and slightly ahead of baling chamber 12 and then loaded up into the bottom of the chamber 12. Baler 10 may be hitched to a towing vehicle (not shown) by a tongue 18, and power for operating the various mechanisms of the baler may be supplied by the towing vehicle, such as the vehicle's power takeoff shaft.

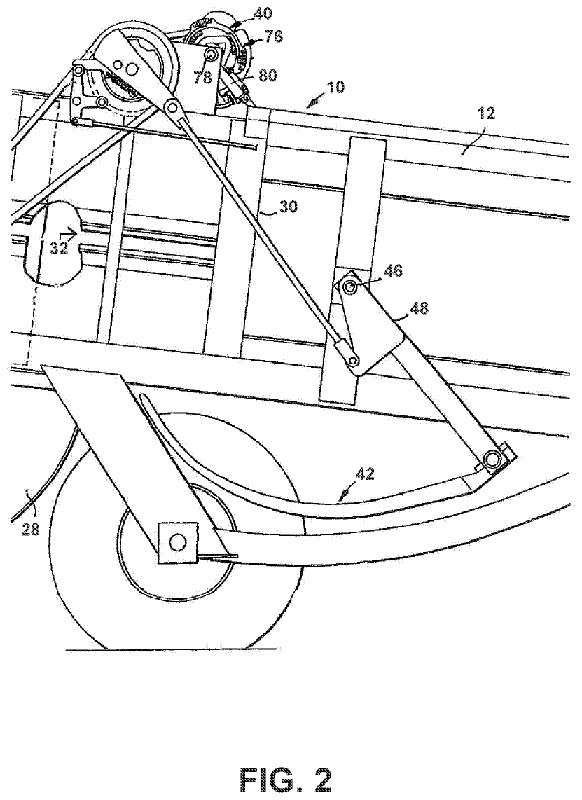

Turning now to FIG. 2, the bale chamber 12 receives material though a curved duct 28. A plunger 30 reciprocates within the bale chamber 12 to intermittently pack fresh charges of material from the duct 28 rearwardly in the chamber 26 in the direction of the arrow 32. When the bales reaches a predetermined size (this is determined by an appropriate bale length sensor (not shown)), a trigger engages a suitable clutch understood by one skilled in the art which in turn is connected to a knotter assembly 40 and a set of needles 42. As will be appreciated, the knotter assembly 40 comprises a set of individual knotters 40 provided crosswise on top of the bale chamber 12 at spaced intervals. Each knotter 40 has an associated needle 42 for assisting in forming an individual loop around a finished bale. When the bale needs tying, the knotter 40 and its respective needle 42 is connected to a source of driving power to initiate the tying operation. As the individual knotters 40 all operate in an identical manner, it suffices to describe the present invention in relation to only one such knotter 40. The needle 42 is swingably mounted on the bale chamber 12 and is swung back and forth across the bale chamber 12 by a linkage 48. The needle 42 has an “at-home” or rest position fully below the bale chamber 12 as illustrated in FIG. 2 and a “full-throw” position extending completely across the bale chamber 12.

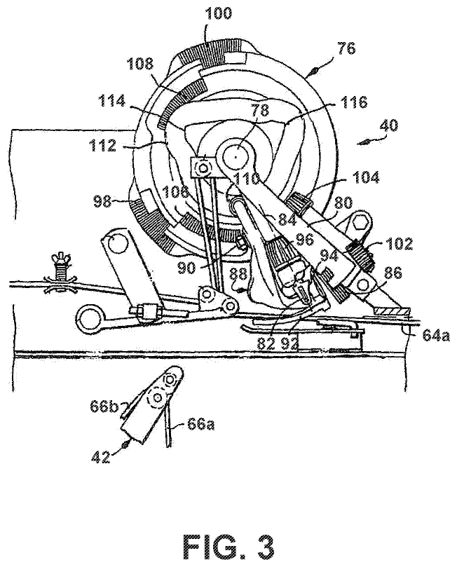

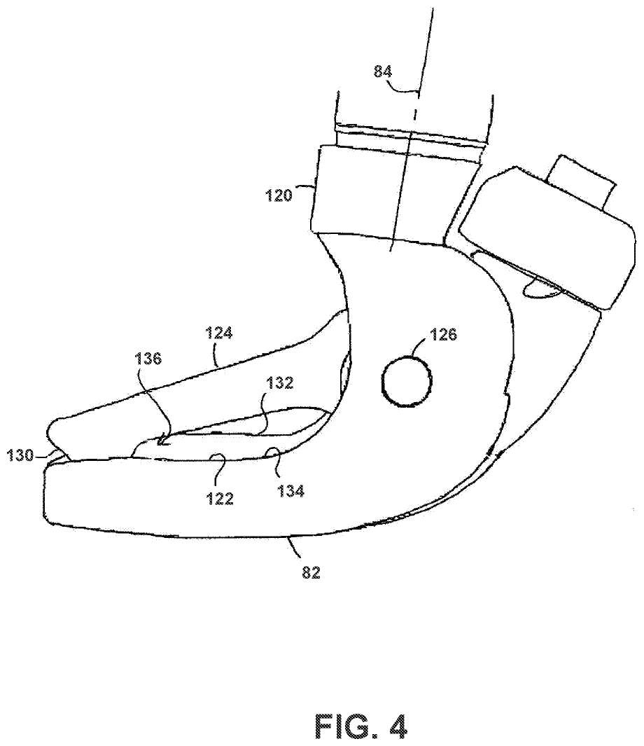

With this short explanation in mind, the details of the embodiment according to the present invention and as illustrated primarily in FIGS. 4-7 will now be described. The knotter assembly 40 is similar in many respects to the knotter assembly shown in U.S. Pat. No. 4,074,623. Turning now to FIG. 3, the knotter assembly 40, which is mountable to the frame 14 of the baler 10, is configured to take strands of twine, broadly binding material, looped around a finished bale and bind the strands with the two knots 68 and 70. The knotter assembly 40 comprises a generally circular knotter disc 76 that is secured to a drive shaft (not shown) for rotation with the latter. The knotter assembly 40 includes a frame 80 that supports a rotary billhook 82 for rotation about an inclined axis 84 and a twine disc assembly 86 comprising a plurality of individual discs is positioned rearwardly adjacent the billhook 82 for holding strands in position for engagement by the billhook 82 during rotation of the latter. The strands are held in the twine disc assembly 86 by a retainer or twine holder 87. In one embodiment, as known previously, a wiper arm 88 pivotably mounted to the frame 80 by a bolt 90 releases the connected strands from the twine disc assembly 86. The lower end of the wiper arm 88 is forked, defining a crotch 92 that opens away from the twine disc assembly 86 beneath the billhook 82. The crotch 92 carries a cutter 94 between the billhook 82 and the twine disc assembly 86 for severing the strands in response to swinging movement of the wiper arm 88 in the proper direction. Such movement of the wiper arm 88 to operate the cutter 94 also serves to engage the proximal areas of the crotch 92 with the knot formed on the billhook 82 for stripping such knot off of the billhook 82.

In the illustrated embodiment, in order to transmit driving power from the knotter disc 76 to the billhook 82, the latter is provided with a pinion gear 96 which is disposed for meshing engagement with a pair of circumferentially spaced gear stretches 98 and 100 on the knotter disc 76. Similarly, driving power is transmitted to the discs of the twine disc assembly 86 through a worm gear drive 102 and a bevel gear 104 in position for sequential meshing engagement with a pair of circumferentially spaced gear sections 106 and 108 on the knotter disc 76. Power to swing the arm 88 about the pivot bolt 90 is obtained through a cam follower 110 at the upper end of the arm 88 beyond the pivot bolt 90 which is disposed within a cam track 112 on the knotter disc 76. A pair of circumferentially spaced cam shoulders 114 and 116 in the track 112 are positioned to sequentially engage the follower 110 to operate the latter.

The knotter assembly 40 performs the first knotting cycle in which the twine disc assembly 86 holds the twine to tie the knot to finish the bale. In presenting the twines, the needle 42 drapes the twines across the billhook 82 and into the twine disc assembly 86. Rotation of the twine disc assembly 86, in combination with the pressing of the twine holder 87, causes the twines to be firmly griped preventing their escape as the billhook 82 begins its rotation. Typically, the twine disc assembly 86 rotates a quarter of a turn and clamps the twines firmly together. The needle 42 then moves downward. During the down travel of the needle 42, the two twines on the back of the needle 42 are placed in an adjacent notch of the twine disc assembly 86 for the second knot. During formation of the first knot, the wiper arm 88, and hence the cutter 94, swings across that portion of the twines between the billhook 82 and the twine disc assembly 86, thereby severing the same. To complete the knot formation, the wiper arm 88 engages the twines which are retained in a twisted manner around the billhook 82. As many aspects of the knotter assembly 40 are well known in the art, further details about known aspects of the knotter assembly 40 need not be explained herein.

Turning now to FIG. 4, the billhook 82 is illustrated according to an embodiment of the invention. The billhook 82 includes billhook casting 120 forming a platform 122, and a billhook tongue 124 connected around a pivot point 126 with the billhook 82. During a tying cycle, the billhook 82 performs at least a first full rotation around its rotation axis 84 during a first knot forming cycle and a second full rotation around its rotation axis 84 during a second knot forming cycle. The billhook tongue 124 is provided at a free end thereof with a downwardly protruding end part 130, and the platform 122 is provided with a first raised lip 132 and a second raised lip 134 forming a channel 136 therebetween configured to receive the protruding end part 130 of the billhook tongue 124. In that way, the billhook tongue 124 can be placed against or very close to the platform 122 so as to firmly grasp the twine. When the billhook 82 rotates around its axis 84, the cam follower 96 will push the billhook tongue 124 away from the platform 122 at the desired time to release the twine.

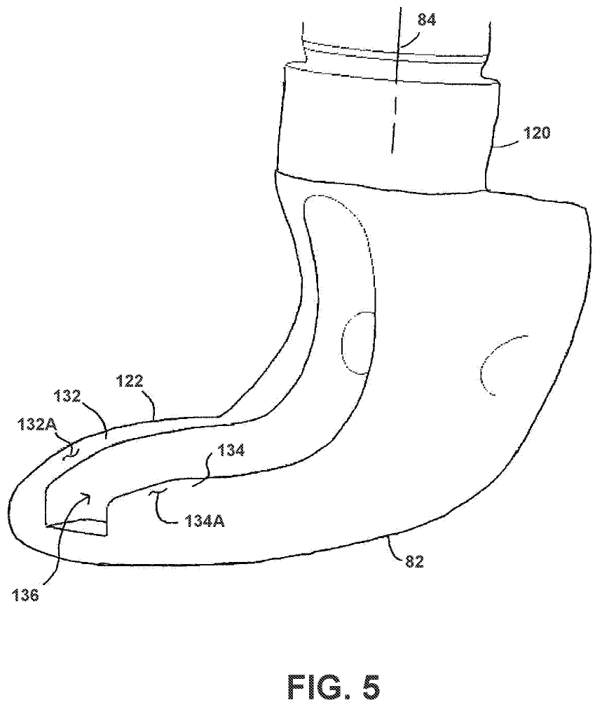

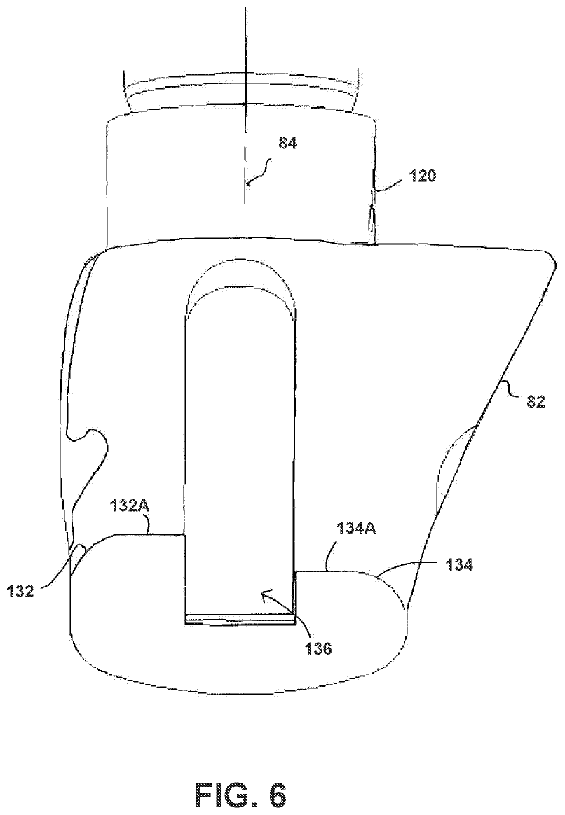

As best seen in FIG. 4, when looking from the side, a vertical gap is apparent between the billhook tongue 124 and the raised lips 132, 134 of the platform 122. In the illustrated embodiment, the billhook tongue 124 is angled downward and the dimensions of the gap between the billhook tongue 124 and the platform 122 varies along the length of the platform 122. According to the invention, an upper surface 132A of the first raised lip 132 of the platform 122 is offset or uneven with an upper surface 134A of the second raised lip 134. As perhaps best seen in FIGS. 5 and 6, the first raised lip 132 is extended in its height dimension, e.g., in a direction generally parallel with the rotation axis 84 of the billhook 82, with respect to the second raised lip 134. Thus, the extended first raised lip 132 closes a portion of the gap between the billhook tongue 124 and the platform 122 at the first raised lip 132.

Desirably, the extended first raised lip 132 closes at least half of the gap when compared to the non extended raised lip 134. In one embodiment, the extended portion of the first raised lip 132 goes from about 1.5 mm to about 3 mm above the second raised lip 134 along the platform 122. In one embodiment, the first raised lip 132 extends at least 1 mm above the second raised lip 134 and may extend up until the entire gap is covered near the protruding end part 130.

Desirably, the higher raised lip 132 is on a front or leading side of the billhook 82, i.e., the side of the billhook 82 that leads in the initial rotational movement when the billhook 82 begins a knot-tying cycle. However, the higher raised lip 132 may be on the trailing side of the billhook 82 without departing from the scope of the invention. It has been found that extending the raised lip 132, especially on the front side of the billhook 82, creates an improved surface that holds the twine tighter without having to increase settings of the knotter assembly 40, such as by tightening a tensioning spring.

The foregoing has broadly outlined some of the more pertinent aspects and features of the present invention. These should be construed to be merely illustrative of some of the more prominent features and applications of the invention. Other beneficial results can be obtained by applying the disclosed information in a different manner or by modifying the disclosed embodiments. Accordingly, other aspects and a more comprehensive understanding of the invention may be obtained by referring to the detailed description of the exemplary embodiments taken in conjunction with the accompanying drawings.

1. A knotter assembly 40 for use in tying knots in strands of binding material used to bind bales of agricultural material formed with a baler 10, the knotter assembly having a rotatably driven knotter disc, a rotary billhook 82 driven by the knotter disc, and a twine disc assembly 86 positioned adjacent the billhook 82 for holding strands of binding material in position for engagement by the billhook 82, wherein the billhook 82 includes billhook casting 120 forming a platform 122, and a billhook tongue 124 connected at a pivot point 126 with the billhook casting, the platform comprising a first raised lip 132 and a second raised lip 134 forming a channel 136 therebetween configured to receive the billhook tongue so as to firmly grasp the binding material, wherein an upper surface 132A of the first raised lip extends above an upper surface 134A of the second raised lip.

2. The knotter assembly of claim 1 wherein during a tying cycle, the billhook performs at least a first full rotation around its rotational axis 84 and the first raised lip is extended in a direction generally parallel with the rotational axis of the billhook.

3. The knotter assembly of claim 2 wherein the first raised lip leads the second raised lip during initial rotational movement of the billhook when the knotter assembly begins a knot-tying cycle.

4. The knotter assembly of claim 3 wherein the billhook tongue is provided at a free end thereof with a downwardly protruding end part 130, and the channel is configured to receive the protruding end part of the billhook tongue.

5. The knotter assembly of claim 2 wherein the first raised lip extends at least 1.0 mm above the second raised lip.
